(19) United States
(12) Patent Application Publication
(10) Pub. No.: US 2015/0141609 A1
(43) Pub. Date: May 21, 2015

(54) POLYESTER - POLYURETHANE ELASTOMERS FROM RENEWABLE SOURCES

(71) Applicant: DOW GLOBAL TECHNOLOGIES LLC, Midland, MI (US)

(72) Inventors: Giuseppe Lista, Modena (IT); Luciano Zanacchi, Solarolo Rainerio (IT)

(73) Assignee: Dow Global Technologies LLC, Midland, MI (US)

(21) Appl. No.: 14/396,232

(22) PCT Filed: Jun. 25, 2013
(86) PCT No.: PCT/EP2013/063303

§ 371 Date: Oct. 22, 2014

(30) Foreign Application Priority Data
Jun. 28, 2012 (IT) MI2012A001140

(51) Int. Cl. C08G 18/32; C08G 18/72

(52) U.S. Cl. CPC C08G 18/3221; C08G 18/72
USPC 528/80

(57) ABSTRACT

Embodiments of the invention encompass polyurethane elastomers which are a reaction product of a reaction mixture that includes a) at least one polyester made using a dicarboxylic acid having a carbon chain of from 9 to 20; b) at least one chain extender; and c) at least one polyisocyanate. At least 20% of the total carbon content of the polyurethane elastomer is from renewable carbon.

Embodiments of the present invention relate to polyurethane elastomers. More particularly, embodiments of the present invention relate to polyurethane elastomers made from renewable sources.

Polyurethane microcellular elastomers are often used in shoe soles. Polyether polyols based on the polymerization of alkylene oxides, polyester polyols, or combinations thereof, are together with isocyanates the major components of such polyurethane systems. The standard polyester polyol used in shoe soles may be based on adipic acid. Dimer fatty acids or dimer fatty diols have also been used to make certain microcellular elastomers which may be useful in shoe soles.

However, such microcellular elastomers based on adipic acid or dimer fatty acids and diols may have unpleasant odors, and the use of dimer fatty acids and diols limits the amount of renewable resource that can be used and still obtain mechanical properties such as tensile strength, tear strength, and elongation at break suitable for such applications as shoe soles. It would be desirable to obtain better mechanical properties than obtained with dimer polyols, or similar properties but with greater renewable content than when using adipate polyols.

Embodiments of the present invention provide for microcellular elastomers having higher levels of renewable carbon incorporated into the elastomer.

Embodiments of the invention encompass polyurethane elastomers which are a reaction product of a reaction mixture that includes a) at least one polyester made using a dicarboxylic acid having a carbon chain of from 9 to 20; b) at least one chain extender; and c) at least one polyisocyanate. At least 20% of a total carbon content of the polyurethane elastomer is from renewable carbon.

Embodiments include the polyurethane elastomers as described above having one or more of the following attributes:
The dicarboxylic acid is formed from ozonolysis of fatty acid or fatty acid ester.
The dicarboxylic acid is azelaic acid.
The at least one polyester is prepared by combining the dicarboxylic acid with at least one glycol component.
The at least one polyester is prepared by combining the dicarboxylic acid with at least one diethylene glycol and at least one monoethylene glycol.
The at least one chain extender includes ethylene glycol.
The at least one polyester includes essentially no adipic acid.
The elastomer has a slight odor according to Swiss standard SNV 195651.
The odor is fruity according to Swiss standard SNV 195651.
The odor is obtained without addition of an olfactory additive.
At least 30% of the total carbon content of the polyurethane elastomer is renewable carbon.

Embodiments of the present invention provide for microcellular elastomers having higher levels of renewable carbon incorporated into the elastomer. Embodiments encompass elastomers that not only have mechanical properties to make the elastomers suitable for use in shoe soles, but also have pleasant scents.

The elastomers may be made from reacting a reaction mixture which includes at least:
a) at least one polyester polyol made using a dicarboxylic acid having a carbon chain of from 9 to 20;
b) at least one chain extender; and
c) at least one polyisocyanate.

The at least one polyester polyol (a) may be made by combining at least a dicarboxylic acid with at least one glycol component. The dicarboxylic acid may have a carbon chain of from 9 to 20 carbons. Examples of such dicarboxylic acids include azelaic acid, sebacic acid, heptane dicarboxylic acid, octane dicarboxylic acid, nonane dicarboxylic acid, decane dicarboxylic acid, undecane dicarboxylic acid, dodecane dicarboxylic acid and higher homologs thereof. In certain some embodiments the dicarboxylic acid is azelaic acid. Azelaic acid may be obtained from the ozonolysis of oleic acid and is available from for example Emery Oleochemicals under the trade name EMEROX.

The at least one glycol component of the polyester polyol used in the embodiments of the present invention may have a molecular weight in the range between about 50 and 650 g/mol. All individual values and subranges between about 50 and about 650 g/mol are included herein and disclosed herein; for example, the amount can be from a lower limit of about 50, 55, 60, 62, 65, 75, 85, 90, 100, 106, 150, or 200 g/mol to an upper limit of about 75, 76, 80, 85, 90, 100, 106, 150, 200, 300, 400, 500, 600, or 650 g/mol. The glycol component may comprise diols such as pentaerythritol, triols such as glycerol and trimethylolpropane, diols, and mixtures thereof. Suitable diols include straight chain aliphatic diols such as monoethylene glycol, diethylene glycol, 1,3-propylene glycol, dipropylene glycol, 1,4-butylene glycol, 1,6-hexylene glycol, branched diols such as neopentyl glycol, 3-methyl pentane glycol, 1,2-propylene glycol, and cyclic diols such as 1,4-bis(hydroxyl-methyl)-cyclohexane and (1,4-cyclohexane-dimethanol). Mixtures of the various diol components are also contemplated.

In an embodiment, the at least one glycol component includes at least monoethylene glycol and diethylene glycol. The weight ratio of monoethylene glycol to diethylene glycol may be between about 1:10 and about 10:1. All individual values and subranges between about 1:10 and about 10:1 are included herein and disclosed herein; for example, the ratio can be between 3:7 and 7:3, 6:4 and 4:6 or 5.5:4.5 and 4.5:5.5. In certain embodiments the weight ratio is about 1:1

The polyester polyol may be formed from dicarboxylic acid and glycol component at a molar ratio in the range from 1:1.0 to 5.0, such as 1:1.05 to 3.0, 1:1.1 to 2.0, or 1:1.2 to 1.4. Thus, the diol may be present in molar excess so as to obtain a polyester terminated at both ends with OH groups.

In an embodiment, the polyester polyol is formed from azelaic acid, monoethylene glycol, and diethylene glycol.

The polyester polyol may be formed by a polymerization reaction. With respect to the method for performing the polymerization reaction, there is no particular limitation, and the polymerization reaction can be performed by using conventional methods known in the art. The polymerization reaction may be aided by a catalyst.

Examples of the catalyst may include metals such as lithium, sodium, potassium, rubidium, cesium, magnesium, calcium, strontium, barium, titanium, zirconium, hafnium, cobalt, zinc, aluminum, germanium, tin, lead, antimony, arsenic, and cerium and compounds thereof. As the metallic compounds, oxides, hydroxides, salts, alkoxides, organic compounds, and the like may be mentioned. Of these catalysts, it is preferred to use titanium compounds such as titanium tetrabutoxide, titanium tetra-n-propoxide, titanium tetra-isopropoxide, titanium 2-ethyl hexanoate, and titanium acetylacetonate tin compounds such as di-n-butyltin dilaurate, di-n-butyltin oxide, and dibutyltin diacetate, lead compounds such as lead acetate and lead stearate.

The polyester may have a molecular weight number average in the range from 1,000 to 5,000, such as from 1,700 to 3,000, 1,800 to 2,500, or 1,900 to 2,200.

The polyester preferably may have a hydroxyl value in the range from 10 to 112, such as from 30 to 80, 40 to 70, or 50 to 60 mgKOH/g. In addition, the polyester may have an acid value of less than 2, such as less than 1.7, less than 1.3, and or less than 1.0.

The at least one chain extender (b). The chain extender is typically used in quantities up to 20 wt. %, especially up to 15 wt. % of the total reaction system. In certain embodiments, the chain extender is from 1 to 10 wt. % of the total reaction system. Representative chain extenders include ethylene glycol, diethylene glycol, 1,3-propane diol, 1,3-butanediol, 1,4-butanediol, dipropylene glycol, 1,2-butylene glycol, 2,3-butylene glycol, 1,6-hexanediol, neopentylglycol, tripropylene glycol, 1,2-ethylhexyldiol, ethylene diamine, 1,4-butylenediamine, 1,6-hexamethylenediamine, 1,5-pentanediol, 1,3-cyclohexandiol, 1,4-cyclohexanediol; 1,3-cyclohexane dimethanol, 1,4-cyclohexane dimethanol, N-methylethanolamine, N-methyliso-propylamine, 4-aminocyclohexanol, 1,2-diaminotheane, 1,3-diaminopropane, hexylmethylene diamine, methylene bis(aminocyclohexane), isophorone diamine, 1,3-bis(aminomethyl), 1,4-bis(aminomethyl) cyclohexane, diethylenetriamine, 3,5-diethyltoluene-2,4-diamine and 3,5-diethyltoluene-2,6-diamine, and mixtures or blends thereof. Suitable primary diamines include for example dimethylthiotoluenediamine (DMTDA) such as Ethacure 300 from Albermarle Corporation, diethyltoluenediamine (DETDA) such as Ethacure 100 from Albemarle (a mixture of 3,5-diethyltoluene-2,4-diamine and 3,5-diethyltoluene-2,6-diamine), and isophorone diamine (IPDA).

The at least one polyisocyanate (c) include aromatic, cycloaliphatic and aliphatic isocyanates. The isocyanate functionality is preferably from about 1.9 to 4, and more preferably from 1.9 to 3.5 and especially from 2.0 to 3.3. Exemplary polyisocyanates include m-phenylene diisocyanate, tolylene-2-4-diisocyanate, tolylene-2-6-diisocyanate, isophorone diisocyanate, 1,3- and/or 1,4-bis(isocyanatomethyl)cyclohexane (including cis- or trans-isomers of either), hexamethylene-1,6-diisocyanate, tetramethylene-1,4-diisocyanate, cyclohexane-1,4-diisocyanate, hexahydrotolylene diisocyanate, methylene bis(cyclohexaneisocyanate) (H₁₂MDI), naphthylene-1,5-diisocyanate, methoxyphenyl-2,4-diisocyanate, diphenylmethane-4,4′-diisocyanate, 4,4′-biphenylene diisocyanate, 3,3′-dimethoxy-4,4′-biphenyl diisocyanate, 3,3′-dimethyl-4-4′-biphenyl diisocyanate, 3,3′-dimethyldiphenyl methane-4,4′-diisocyanate, 4,4′,4″-triphenyl methane triisocyanate, a polymethylene polyphenylisocyanate (PMDI), tolylene-2,4,6-triisocyanate and 4,4′-dimethyldiphenylmethane-2,2′,5,5′-tetraisocyanate. In some embodiments, the polyisocyanate is diphenylmethane-4,4′-diisocyanate, diphenylmethane-2,4′-diisocyanate, PMDI, tolylene-2,4-diisocyanate, tolylene-2,6-diisocyanate or mixtures thereof. Diphenylmethane-4,4′-diisocyanate, diphenylmethane-2,4′-diisocyanate and mixtures thereof are generically referred to as MDI, and all may be used. Tolylene-2,4-diisocyanate, tolylene-2,6-diisocyanate and mixtures thereof are generically referred to as TDI, and all may be used.

Embodiments encompass the at least one polyisocyanate being an isocyanate terminated prepolymer of any of the polyisocyantes and polyols mentioned above (including polyester polyol). In certain embodiments the polyisocyanate is an isocyanate terminated prepolymer of MDI and adipic acid polyester polyol (polyadipates) having an isocyanate content of between about 15 and 24 weight percent.

The at least one polyisocyanate (c) may comprise at least 10 wt. %, 15 wt. %, 20 wt. %, 25 wt. %, 30 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. %, or 90 wt. % of the elastomer composition. The one or more organic polyisocyanate components (b) may comprise up to 15 wt. %, 20 wt. %, 25 wt. %, 30 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. %, 90 wt. %, or 95 wt. % of the elastomer composition.

For elastomers, coating and adhesives the isocyanate index is generally between 80 and 125, preferably between 90 to 110. For prepolymers the isocyanate index is generally between 200 and 5,000, preferably between 200 to 2,000.

The reaction system may further comprise one or more catalyst components (d). Catalysts are typically used in small amounts, for example, each catalyst being employed from 0.0015 to 5 wt. % of the total reaction system. The amount depends on the catalyst or mixture of catalysts and the reactivity of the polyols and isocyanate as well as other factors familiar to those skilled in the art.

Although any suitable catalyst may be used. A wide variety of materials are known to catalyze polyurethane reactions including amine-based catalysts and tin-based catalysts. Preferred catalysts include tertiary amine catalysts and organotin catalysts. Examples of commercially available tertiary amine catalysts include: trimethylamine, triethylamine, N-methylmorpholine, N-ethylmorpholine, N,N-dimethylbenzylamine, N,N-dimethylethanolamine, N,N-dimethylaminoethyl, N,N,N′,N′-tetramethyl-1,4-butanediamine, N,N- dimethylpiperazine, 1,4-diazobicyclo-2,2,2-octane, bis(dimethylaminoethyl)ether, triethylenediamine and dimethylalkylamines where the alkyl group contains from 4 to 18 carbon atoms.

Mixtures of these tertiary amine catalysts are often used.

Examples of commercially available amine catalysts include NIAX™ A1 and NIAX™ A99 (bis(dimethylaminoethyl)ether in propylene glycol available from Momentive Performance Materials), NIAX™ B9 (N,N-dimethylpiperazine and N-N-dimethylhexadecylamine in a polyalkylene oxide polyol, available from Momentive Performance Materials), DABCO® 8264 (a mixture of bis(dimethylaminoethyl)ether, triethylenediamine and dimethylhydroxyethyl amine in dipropylene glycol, available from Air Products and Chemicals), DABCO® 33LV (triethylene diamine in dipropylene glycol, available from Air Products and Chemicals), DABCO® BL-11 (a 70% bis-dimethylaminoethyl ether solution in dipropylene glycol, available from Air Products and Chemicals, Inc), NIAX™ A-400 (a proprietary tertiary amine/carboxylic salt and bis (2-dimethylaminoethyl)ether in water and a proprietary hydroxyl compound, available from Momentive Performance Materials); NIAX™ A-300 (a proprietary tertiary amine/carboxylic salt and triethylenediamine in water, available from Momentive Performance Materials); POLYCAT® 58 (a proprietary amine catalyst available from Air Products and Chemicals), POLYCAT® 5 (pentamethyl diethylene triamine, available from Air Products and Chemicals) POLYCAT® 8 (N,N-dimethyl cyclohexylamine, available from Air Products and Chemicals) and POLYCAT® 41 (a proprietary amine catalyst available from Air Products and Chemicals).

Examples of organotin catalysts are stannic chloride, stannous chloride, stannous octoate, stannous oleate, dimethyltin dilaurate, dibutyltin dilaurate, other organotin compounds of the formula SnRn(OR)4-n, wherein R is alkyl or aryl and n is 0-2, and the like. Organotin catalysts are generally used in conjunction with one or more tertiary amine catalysts, if used at all. Commercially available organotin catalysts of interest include KOSMOS® 29 (stannous octoate from Evonik AG), DABCO® T-9 and T-95 catalysts (both stannous octoate compositions available from Air Products and Chemicals).

Additives such as surface active agents, antistatic agents, plasticizers, fillers, flame retardants, pigments, stabilizers such as antioxidants, fungistatic and bacteriostatic substances and the like are optionally used in the reaction system.

The elastomers may have a slight and fruity smell (as measured according to Swiss standard SNV 195651). The slight and fruity smell may be obtained without addition of an olfactory additive.

The elastomers may have a Shore A hardness of at least 30, 35, 40, 45, 50, 52, 53, 54, 55, 60, 65, 70, 75, or 80 as measured according to DIN 53543.

The elastomers may have a Tensile strength of at least 6.0, 6.5, 7.0, or 7.5 N/mm² as measured according to DIN 53543.

The elastomers may have an elongation at break of at least 400, 420, 430, 450, 460, 470, 480, 490, 495, 500, 505, 510, 550, 600, or 700% as measured according to DIN 53543.

The elastomers may have a Tear strength of at 6.0, 6.5, 7.0, 7.5, 8.0, 8.5, or 9.0 N/mm² as measured according to DIN 53543.

The elastomers may have renewable carbon contents above about 10% based on the total carbon content of the elastomers. The renewable carbon content may be above about 10%, 15%, 20%, 25%, 30%, 35%, 40%, 45%, 50%, or 55%. The renewable carbon contents of the elastomers may be calculated and/or measured as described in PU Magazine, Vol. 5, No. 6, December 2008, pages 368-372.

The elastomer according to the embodiments of the present invention may be suitable for use, inter alia, as shock absorbers/“spring aids” for automotive suspension, tires (energy absorbing wheels for buggies, trolleys) and technical parts (car seat components), and is particularly suitable for use in shoes. The elastomer can be used in dual density outsoles, single density boots, single density casual/formal, single density sandals, single density insoles, and especially in dual and single density midsoles.

### EXAMPLES

The following examples are provided to illustrate the embodiments of the invention, but are not intended to limit the scope thereof. All parts and percentages are by weight unless otherwise indicated.

The following materials are used:
Azelaic acid Available from Emery Oleochemicals under trade name EMEROX 1175.
Diethylene glycol Available from MeGlobal.
Monoethylene glycol Available from INEOS.
VORALAST*GT 5000 A 2000 MW polyester diol produced from adipic acid, glutaric acid, succinic acid, dimer acid, ethylene glycol, and diethylene glycol. Available from The Dow Chemical Company.
VORALAST*GP 3100 A 2000 MW polyester diol produced from adipic acid, ethylene glycol and diethylene glycol. Available from The Dow Chemical Company.
VORALAST*GB 203 A mixture of ethylene glycol, triethylenediamine, a silicon based surfactant, and water. Available from The Dow Chemical Company.
VORALAST*GT 967 An isocyanate terminated prepolymer of MDI and adipic acid polyester polyol (polyadipates) having an isocyanate content of 18.3 wight percent. Available from The DOW Chemical Company
VORANOL*CP 6001 A polyether triol having a hydroxyl number of 28 and a molecular weight of 6,000. It is prepared from 85 percent by weight of polymerized propylene oxide, which has been capped with 15 percent by weight of ethylene oxide. Available from The Dow Chemical Company.
VORANOL*EP 1900 A polyether diol having a hydroxyl number of 28 and a molecular weight of 4000. It is prepared from 80 percent by weight of polymerized propylene oxide, which has been capped with 20 percent by weight of ethylene oxide. Available from The Dow Chemical Company.
SPECFLEX*NC 700 A styrene acrylonitrile based copolymer polyol having an average hydroxyl number of 20 and a carrier molecular weight of 4800. It has a solids content of 42 percent by weight. Available from The Dow Chemical Company.
1,4-butanediol A chain extender.
DABCO 33 LB A tertiary amine catalyst in butanediol. Available from Air Products.
DABCO T12N An organo-tin salt, dibutyltin dilaurate. Available from Air Products.
DC 193 A silicone surfactant is DC 193. Available from Dow Corning.
VORALAST* GE 115 Isocyanate A mixture of 4,4′-diphenylmethane diisocyanate polyols and glycols. Available from The Dow Chemical Company.
* VORALAST, VORANOL, and SPECFLEX are trademarks of The Dow Chemical Company.

### Polyester 1

A polyester composition is prepared by combining azelaic acid (0.79 kg), diethylene glycol (0.18 kg) and monoethylene glycol (0.17 kg). The reaction is performed at 220° C. under strong agitation at 200 rpm until the desired conversion is reached (a residual acid value of below 2 mgKOH/g). Water formed by the reaction is removed under nitrogen stripping at 5 L Nitrogen per minute and condensed in a separate flask. The final polyester is then cooled at room temperature. The amount of Polyester 1 obtained is 1.0 kg, with 0.14 kg water removed. Polyester 1 has a renewable carbon content of 78% according to the requirements of ISO 17025.

### Example 1 and Comparative Examples A, B, and C

Polyester based elastomers (Comparative Examples A and B and Example 1) are made by combining a polyol component of VORALAST GB 203 and either Polyester 1 (Example 1), VORALAST GT 5000 (Comparative Example A) or VORALAST GP 3100 (Comparative Example B) in a laboratory scale up pouring polyurethane machine commercially available from GUSBI Italy under designation laboratory version of Gusbi Linear P18 machine. The polyol component (100 parts by weight) at 45-50° C. is reacted with prepolymer Voralast GT 967 (88 pbw) at a temperature of 30-35° C. to form several sheets of polyurethane measuring 200 mm×200 mm×10 mm. Polyurethane sheets are tested according to the procedures of DIN 53543 and properties are displayed in the table below. The renewable carbon contents of the elastomers are calculated as described in PU Magazine, Vol. 5, No. 6, December 2008, pages 368-372.

For odor comparisons, polyester based elastomers Example 1 and Comparative Example B are compared to a polyether based elastomer (Comparative Example C). Comparative Example C is made by combing VORANOL EP 1900, VORANOL CP 6001, SPECFLEX NC 700, 1,4 butanediol, DABCO 33 LB, DABCO T12N, DC 193, and water. The polyol component (100 parts by weight) at 45-50° C. is reacted with prepolymer Voralast GE 115 (68 pbw) at a temperature of 30-35° C. to form several sheets of polyurethane measuring 200 mm×200 mm×10 mm. Odor comparisons is performed according to Swiss standard SNV 195651 1968 section 13.1.

| | Comparative | Comparative | Comparative | |
|---|---|---|---|---|
| | Example A | Example B | Example C | Example 1 |
| VORANOL EP 1900 | | | 59.63 | |
| VORANOL CP 6001 | | | 16.91 | |
| SPECFLEX NC 700 | | | 12.00 | |
| VORALAST GT 5000 | 91.65 | | | |
| VORALAST GP 3100 | | 91.65 | | |
| Polyester 1 | | | | 91.65 |
| VORALAST GB 203 | 8.35 | 8.35 | | 8.35 |
| 1,4 Butanediol | | | 9.50 | |
| DABCO 33 LB | | | 1.30 | |
| DABCO T12N | | | 0.010 | |
| DC 193 | | | 0.20 | |
| Water | | | 0.45 | |
| VORALAST GT 967 | 88 | 88 | | 88 |
| isocyanate | | | | |
| VORALST GE 115 | | | 68 | |
| Isocyanate | | | | |
| % Renewable Carbon | 7.5 | 0 | | 33 |
| Content in the final PU | | | | |
| | Mechanical/physical tests according to DIN 53543 | | | |
| Hardness (Shore A) | 55 | 55 | | 55 |
| Tensile strength (N/mm²) | 4.9 | 6.5 | | 7.5 |
| Elongation (%) | 405 | 430 | | 510 |
| Tear strength (N/mm) | 7.2 | 8 | | 7.5 |
| Flex fatigue before | 100000 | 100000 | | 100000 |
| Hydrolysis (cycles) | | | | |
| Abrasion (mm³) | 100 | 70 | | 110 |
| | Odor Profile according to Swiss standard SNV 195651, 1968 | | | |
| Intensity | | Slight/intense/ | Slight/intense/ | Slight/slight/ |
| | | slight/slight | intense/intense | slight/slight |
| Odor profile (qualitative) | | Sauted | Rubber like | Fruity |

While the foregoing is directed to embodiments of the present invention, other and further embodiments of the invention may be devised without departing from the basic scope thereof, and the scope thereof is determined by the claims that follow.

1. A polyurethane elastomer comprising a reaction product of a reaction mixture, the reaction mixture comprising:
a) at least one polyester made using a dicarboxylic acid having a carbon chain of from 9 to 20;
b) at least one chain extender; and
c) at least one polyisocyanate; and
wherein at least 20% of a total carbon content of the polyurethane elastomer is renewable carbon.

2. The polyurethane elastomer of claim 1, wherein the dicarboxylic acid is formed from ozonolysis of fatty acid or fatty acid ester.

3. The polyurethane elastomer of claim 2, wherein the dicarboxylic acid is azelaic acid.

4. The polyurethane elastomer of claim 1, wherein the at least one polyester is prepared by combining the dicarboxylic acid with at least one glycol component.

5. The polyurethane elastomer of claim 1, wherein the at least one polyester is prepared by combining the dicarboxylic acid with at least one diethylene glycol and at least one monoethylene glycol.

6. The polyurethane elastomer of claim 1, wherein the at least one chain extender comprises ethylene glycol.

7. The polyurethane elastomer of claim 1, wherein the at least one polyester comprises essentially no adipic acid.

8. The polyurethane elastomer of claim 1, wherein the elastomer has a slight odor according to Swiss standard SNV 195651.

9. The polyurethane elastomer of claim 8, wherein the odor is fruity according to Swiss standard SNV 195651.

10. The polyurethane elastomer of claim 8, wherein the odor is obtained without addition of an olfactory additive.

11. The polyurethane elastomer of claim 8, wherein at least 30% of the total carbon content of the polyurethane elastomer is renewable carbon.
